(19) United States
(12) Patent Application Publication
(10) Pub. No.: US 2014/0211320 A1
(43) Pub. Date: Jul. 31, 2014

(54) VISUAL LINE DETECTION DEVICE

(71) Applicant: KABUSHIKI KAISHA TOSHIBA, Tokyo (JP)

(72) Inventor: Takehiro Hori, Ome-shi (JP)

(73) Assignee: KABUSHIKI KAISHA TOSHIBA, Tokyo (JP)

(21) Appl. No.: 14/016,925

(22) Filed: Sep. 3, 2013

Related U.S. Application Data
(63) Continuation of application No. PCT/JP2013/058385, filed on Mar. 22, 2013.

(30) Foreign Application Priority Data
Jan. 31, 2013 (JP) 2013-017897

(51) Int. Cl. G02B 27/01

(52) U.S. Cl. CPC G02B 27/017
USPC 359/630

(57) ABSTRACT

According to one embodiment, a visual line detection device comprises a lens, a frame holding the lens, a beam splitter transmitting light from a visual field in a direction of user's eyes while reflecting a part of the light from the visual field in a direction substantially parallel to a surface of the lens, and transmitting the light from the user's eyes in a direction of the visual field while reflecting the part of the light from the user's eyes in the direction substantially parallel to the surface of the lens, a first light taking module taking the light from the user's eyes reflected by the beam splitter, and a second light taking module taking the light from the visual field reflected by the beam splitter.

### CROSS-REFERENCE TO RELATED APPLICATIONS

This application is a Continuation Application of PCT Application No. PCT/JP2013/058385, filed Mar. 22, 2013 and based upon and claiming the benefit of priority from Japanese Patent Application No. 2013-017897, filed Jan. 31, 2013, the entire contents of all of which are incorporated herein by reference.

### FIELD

Embodiments described herein relate generally to a visual line detection device.

### BACKGROUND

In recent years, a head mount display (HMD) has been received attention as a form of a wearable computer. Since the HMD is in the shape of a hat or eyeglasses, the HDM is convenient for carrying and can be utilized any time. The HDM can provide a user with information such as a guidance, memos about a person due to image recognition of a face, and peripheral information in real time. Furthermore, the HDM is also able to see a real image and an aerial image by superimposing the images in a visual field of the user, and a variety of use forms have been proposed.

A visual line input interface using the visual line has been commercialized as either a man-machine interface configured to operate a computer or home appliances. When roughly dividing, in a visual line input device, there are a contact type in which visual line detecting instrument is mounted on a head, and a non-contact type in which nothing is mounted on the head. In the contact type, since a device such as a HMD is mounted on the head, it is possible to detect the visual line by tracking the visual line of the user even when the posture of the user changes.

In the HMD with a conventional visual line detecting function, since a visual line detecting camera is placed in front of the eyes of the user, the HDM blocks the visual field of the user. In addition, the thickness in the forward direction of the HMD inevitably increases, the volume increases, the feeling of wear is poor, and the burden on the user is large. Furthermore, there has been a desire for improvement to a strange appearance of a wearer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an external perspective view illustrating an example of a visual line detection device according to a first embodiment.

FIG. 2 is a front view illustrating the example of the visual line detection device according to the first embodiment.

FIG. 3 is a partial cross-sectional view illustrating the example of the visual line detection device according to the first embodiment.

FIG. 4 is an enlarged view of a part of the partial cross-sectional view illustrated in FIG. 3 according to the first embodiment.

FIG. 5 is a diagram illustrating an example of a state in which a first through hole according to the first embodiment is located at a position shifted from a center line.

FIG. 6 is an external perspective view illustrating the example of a frame in the state of removing a lens according to the first embodiment.

FIG. 7 is a front view illustrating another example of a visual line detection device according to the first embodiment.

FIG. 8 is a partial cross-sectional view illustrating the example of the visual line detection device according to the first embodiment.

FIG. 9 is an external perspective view illustrating an example of a frame in the state of removing the lens in the other example of the visual line detection device according to the first embodiment.

FIG. 10 is a block diagram illustrating an example of a functional element of the visual line detection device according to the first embodiment.

FIG. 11 is an external perspective view illustrating an example of a visual line detection device according to a second embodiment.

FIG. 12 is a front view illustrating the example of the visual line detection device according to the second embodiment.

### DETAILED DESCRIPTION

Various embodiments will be described hereinafter with reference to the accompanying drawings.

In general, according to one embodiment, a visual line detection device includes a lens, a frame, a beam splitter inside the lens, a first light taking module in the vicinity of the periphery of the lens in the frame, and a second light taking module in the vicinity of the periphery of the lens in the frame. The frame is configured to hold the lens. The beam splitter is configured to transmit light from a visual field in a direction of eyes of a user while reflecting a part of the light from the visual field in a direction substantially parallel to a surface of the lens, and transmit the light from the eyes of the user in a direction of the visual field while reflecting the part of the light from the eyes of the user in the direction substantially parallel to the surface of the lens. The first light taking module is configured to take the light from the eyes of the user reflected by the beam splitter. The second light taking module is configured to take the light from the visual field reflected by the beam splitter.

### First Embodiment

Hereinafter, the first embodiment will be described with reference to the drawings. A visual line detection device 1 according to the first embodiment is a visual line detection device of a type mounted on a head, for example, there is a hat type, a helmet type, or a goggles and eyeglasses type. The hat type and the helmet type are mounted on the head, and have a structure in which the visual line detection device portion hangs down from a flange portion. The goggles and eyeglasses type have a shape similar to working goggles or so-called eyeglasses, and is small and lightweight.

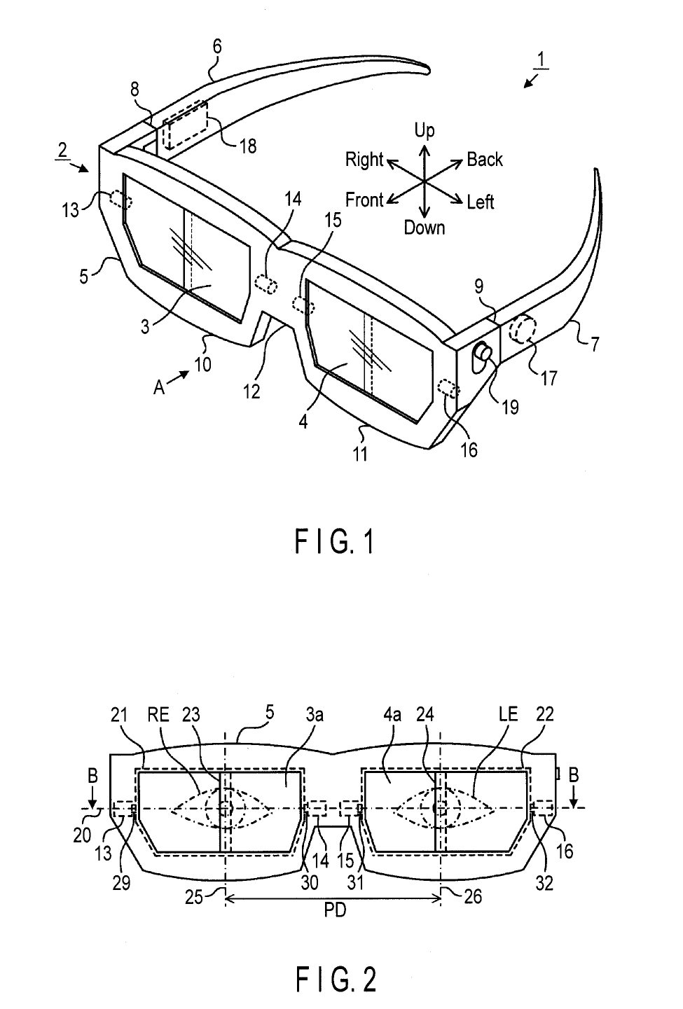

The eyeglasses type will be mainly described in the present embodiment. FIG. 1 is an external perspective view illustrating a visual line detection device 1 according to the embodiment. The visual line detection device 1 includes a frame 2, a right lens 3, and a left lens 4. The frame 2 includes a front 5, a right temple 6, a left temple 7, a right hinge 8, and a left hinge 9. The front 5 includes a right rim 10 and a left rim 11 surrounding each of the left and right lenses 3 and 4, and a bridge 12 that connects the right rim 10 and the left rim 11. The left and right lenses 3 and 4 are fixed by being fitted into grooves 21 and 22 (see FIG. 2) provided inside the right and left rims 10 and 11. In addition, FIG. 1 illustrates arrows indicating directions of up, down, front, back, left and right of the visual line detection device 1.

Visual line detecting cameras 13 and 15, visual field imaging cameras 14 and 16, a power supply unit 17 including a power supply module, and a main circuit board 18 including a controller, an image processor or the like are placed inside the frame 2. For example, the visual line detecting cameras 13 and 15, and the visual field imaging cameras 14 and 16 are placed inside the front 5, the power supply unit 17 is placed inside the left temple 7, and the main circuit board 18 is placed inside the right temple 6. For example, these electrical circuit components are connected by a lead wire and a flexible wiring board (not illustrated).

A switch 19 configured to turn on and off the power supply of the visual line detection device 1 is arranged in a part on the outer surface side of the frame 2. For example, the switch 19 is placed in the vicinity of the front of the left temple 7.

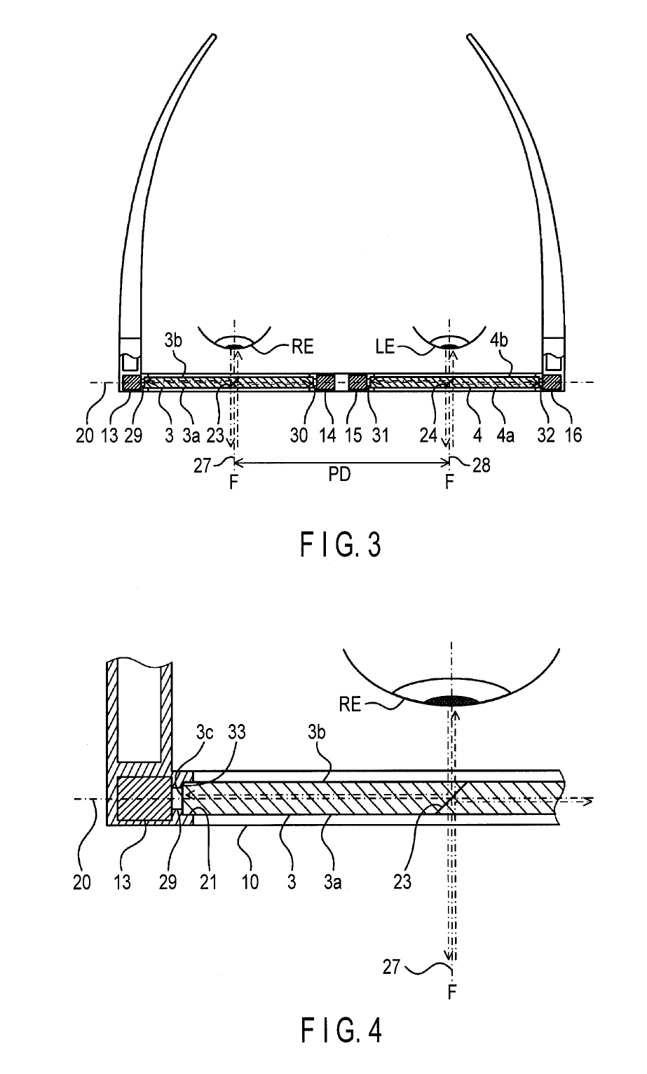

FIG. 2 illustrates a front view of the visual line detection device 1, and is a diagram viewed from a direction A illustrated in FIG. 1. FIG. 3 is a partial cross-sectional view of the visual line detection device 1, and illustrates a cross-section taken along line B-B illustrated in FIG. 2. Since a drawing is complicated, a part of hatching is omitted in FIG. 3. FIG. 4 is a partial enlarged view of the partial cross-sectional view illustrated in FIG. 3. In FIG. 2, a center line 20 of the lateral direction is substantially equal to a line that connects the central positions of the pupil when a right eye RE and a left eye LE of the user see the front direction. The front direction is a direction of a point at a distance (for example, tens of meters or hundreds of meters or more) sufficiently separated forward from the lenses 3 or 4 on a normal line at substantially central positions of the front surfaces 3a or 4a of the lens 3 or 4. Furthermore, the center line 20 passes through the center in the thickness direction of the lenses 3 and 4.

In FIG. 2, the lens 3 includes a beam splitter 23, and similarly, the lens 4 includes a beam splitter 24. For example, the beam splitters 23 and 24 serve as half mirrors. The center lines 25 and 26 in the vertical direction of the beam splitters 23 and 24 are present in front of the central position of the pupil when the right eye RE and the left eye LE of each user see the front direction. Furthermore, the center lines 25 and 26 pass through the center in the thickness direction of each of the lenses 3 and 4. An interval between the center lines 25 and 26 is a pupil interval PD. The center line 20 in the lateral direction is perpendicular to the beam splitters 23 and 24 and intersects with the center lines 25 and 26.

In FIG. 3, center lines (center lines in the longitudinal direction) 27 and 28 of the beam splitters 23 and 24 in a direction perpendicular to the front surfaces 3a and 4a or the rear surfaces 3b and 4b of the lenses 3 and 4, the direction intersecting with the center line 20, pass through the central position of the pupil when the right eye RE and of the left eye LE of each user see the front direction.

The beam splitters 23 and 24 transmit light from the visual field in the direction of the eyes of the user while reflecting a part of the light from the visual field in a direction substantially parallel to the lens surfaces 3a and 4a, and transmit light from the eyes (pupil or iris) of the user in the direction of the visual field while reflecting a part of the light from the eyes of the user in a direction substantially parallel to the lens surfaces 3a and 4a.

In FIGS. 3 and 4, when the light parallel to the center line 27 among beams of light from the front F of the visual field reaches the beam splitter 23 of the lens 3, almost half light is reflected in a direction substantially parallel to the lens surface 3a and goes toward the visual field imaging camera 14. In addition, almost half light is transmitted and goes toward the right eye RE of the user. Similarly, when light parallel to the center line 28 among the beams of light from the front F of the visual field reaches the beam splitter 24 of the lens 4, almost half light is reflected in a direction substantially parallel to the lens surface 4a and goes toward the visual field imaging camera 16. In addition, almost half light is transmitted and goes toward the left eye LE of the user.

In FIGS. 3 and 4, when light parallel to the center line 27 among the beams of light from the right eye RE of the user reaches the beam splitter 23 of the lens 3, almost half light is reflected in a direction substantially parallel to the lens surface 3a and goes toward the visual line detecting camera 13. In addition, almost half light is transmitted and goes toward the front F of the visual field. Similarly, light parallel to the center line 28 among the beams of light from the left eye LE of the user reaches the beam splitter 24 of the lens 4, almost half light is reflected in a direction substantially parallel to the lens surface 4a and goes toward the visual field detecting camera 15. In addition, almost half light is transmitted and goes toward the front F of the visual field.

In the frame 2, first light taking modules 29 and 31 configured to take the light from the eyes of the user reflected by the beam splitters 23 and 24 are disposed in the vicinity of the periphery of the lenses 3 and 4. Furthermore, in the frame 2, second light taking modules 30 and 32 configured to take the light from the visual field reflected by the beam splitters 23 and 24 are disposed in the vicinity of the periphery of the lenses 3 and 4. The first light taking modules 29 and 31 and the second light taking modules 30 and 32 are disposed in the vicinity of the opposite sides of the lenses 3 and 4 with each of the beam splitters 23 and 24 interposed therebetween.

The first light taking modules 29 and 31 are first through holes 29 and 31 for taking the light from the eyes of the user. In the grooves 21 and 22 provided inside the right and left rims 10 and 11 of the frame 2, the first through holes 29 and 31 are disposed at a location in which the light from the right eye RE and the left eye LE of the user reflected by the beam splitters 23 and 24 reaches.

The shape of the first through holes 29 and 31 is a circle, an oval, a rectangle, a polygon or the like. Furthermore, for example, if the shape is circular, the size of the first through holes 29 and 31 is 1 mm to several mm in diameter. Light from the eyes of the user reflected by the beam splitters 23 and 24 passes through each of the first through holes 29 and 31, and enters the visual line detecting cameras 13 and 15 disposed in the vicinity of the first through holes 29 and 31 or in proximity thereto.

The second light taking modules 30 and 32 are second through holes 30 and 32 for taking the light from the visual field. In the grooves 21 and 22 provided inside the right and left rims 10 and 11, second through holes 30 and 32 are disposed at a location in which the light from the front F of the visual field reflected by the beam splitters 23 and 24 reaches.

The shape of the second through holes 30 and 32 is a circle, an oval, a rectangle, a polygon or the like. Furthermore, for example, if the shape is circular, the size of the second through holes 30 and 32 is 1 mm to several mm in diameter. Light from the front F of the visual field reflected by the beam splitters 23 and 24 passes through each of the second through hole 30 and 32, and enters the visual field imaging cameras 14 and 16 disposed in the vicinity of the second through holes 30 and 32 or in proximity thereto. In addition, if the direction of the reflecting surface of the beam splitters 23 and 24 changes, the left and right positions of the first through hole 29 and 31 and the second through holes 30 and 32 change.

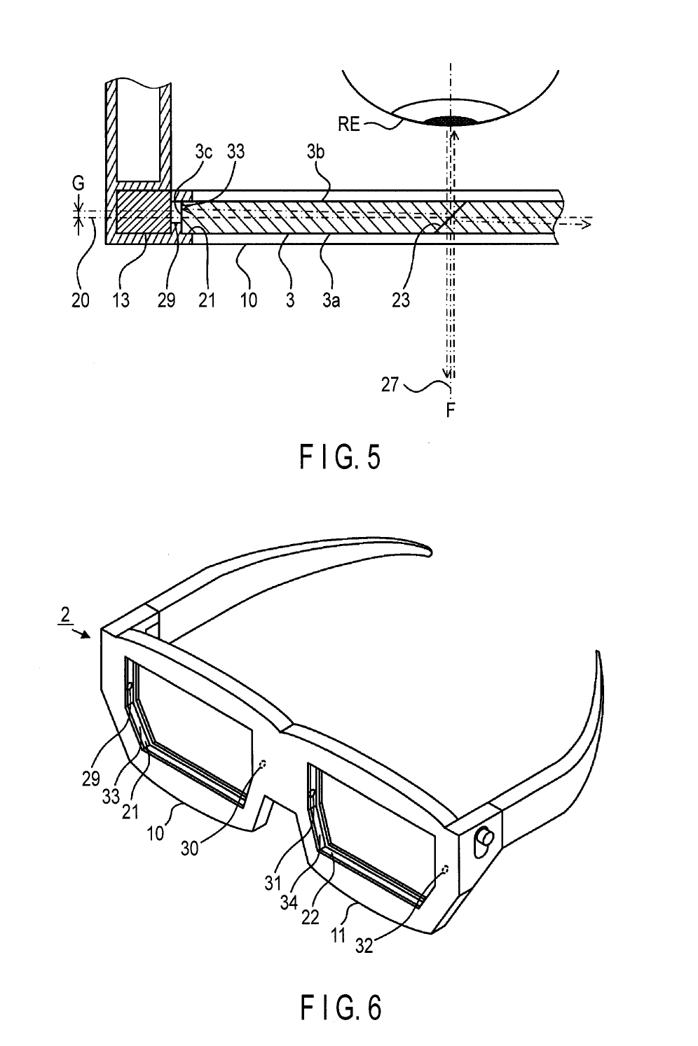

FIG. 5 is a diagram illustrating a state in which the first through hole 29 is shifted from the center line 20. As illustrated in FIG. 5, the first through hole 29 can be installed at a position shifted in the thickness direction of the lens within the range of the thickness of the lens. For example, even when an angle from the lens surface 3a of the beam splitter 23 is slightly shifted, the first through hole 29 may be installed such that the position thereof is shifted by a distance G in accordance with this shift. When light parallel to the center line 27 among the beams of light from the right eye RE of the user reaches the beam splitter 23 of the lens 3, almost half light is reflected in a direction substantially parallel to the lens surface 3a, and goes toward the visual line detecting camera 13. The same is also true for the second through hole 30. The same is also true for the first through hole 31 and the second through hole 32, and even though the angle from the lens surface 4a of the beam splitter 24 is slightly shifted, the first through hole 31 and the second through hole 32 may be disposed such that the position is shifted in accordance with the shift.

FIG. 6 is an external perspective view illustrating the frame 2 in the state of removing the lenses 3 and 4. The right and left rims 10 and 11 are provided with lens fixing grooves 21 and 22, and the first through holes 29 and 31, and the second through holes 30 and 32 are provided on the bottom surfaces 33 and 34 (surfaces in which side surfaces 3c and 4c of the lens face) of the grooves 21 and 22.

The bottom surface 33 and 34 of the grooves 21 and 22 may be in a surface state which does not reflect black or light. For example, almost half of the light emitted from the vicinity of the second through hole 30 passes through the beam splitter 23, reaches the first through hole 29 for taking the light from the right eye RE of the user, and enters the visual line detecting camera 13. This light becomes noise for the video due to the visual line detecting light. Therefore, the vicinity of the second through hole 30 may be as small as possible. Since the light from the front F of the visual field reaches the vicinity of the second through hole 30, the vicinity of the second through hole 30 may be in the surface state of preventing the reflection. For example, black painting, antireflection paint or the like may be applied to the vicinity of the second through hole 30.

Furthermore, in contrast, half of the light from vicinity of the first through hole 29 passes through the beam splitter 23 and enters the second through hole 30. This light becomes noise for the video picked up by the visual field imaging light G. Therefore, the vicinity of the first through hole 29 may be in the surface state of preventing the reflection.

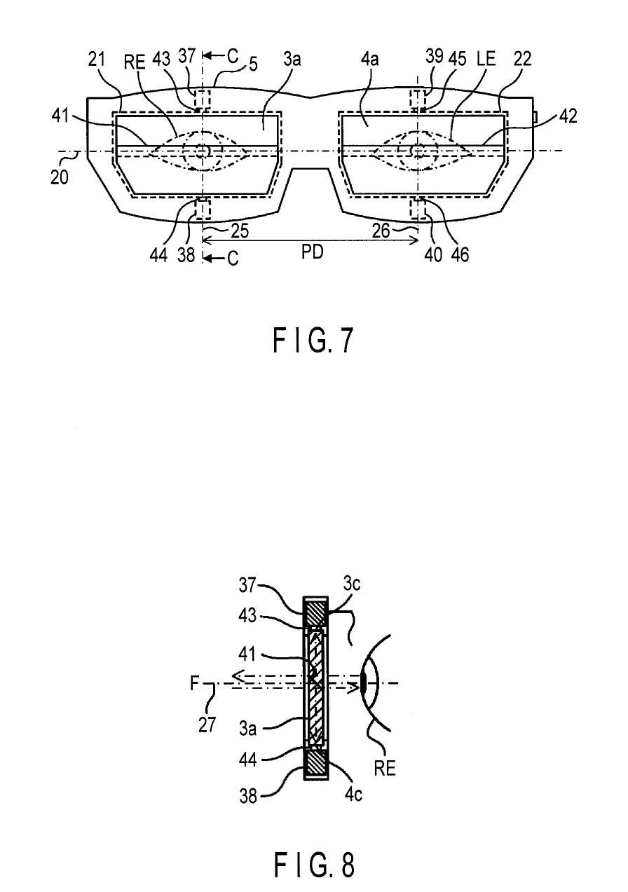

FIG. 7 is a front view illustrating another example of the visual line detection device 1 in the exemplary embodiment. FIG. 8 is a partial cross-sectional view of the visual line detection device 1, and illustrates a cross-section CC illustrated in FIG. 7. Since a drawing becomes complicated, hatching is partially omitted in FIG. 8. The first light taking modules 29 and 31 and the second light taking modules 30 and 32 of the visual line detection device 1 illustrated in FIGS. 1 to 6 are placed in the vicinity of the left and right opposite sides of the lenses 3 and 4 with each of the beam splitters 23 and 24 interposed therebetween, but the first light taking modules 43 and 45 and the second light taking modules 44 and 46 illustrated in FIGS. 7 to 9 are placed in the vicinity of the upper and lower opposite sides of the lenses 3 and 4 with each of the beam splitters 41 and 42 interposed therebetween.

In FIG. 7, the beam splitters 41 and 42 extend in the lateral direction of the lenses 3 and 4. The center line in the lateral direction of the beam splitters 41 and 42 corresponds to the center line 20. In FIG. 8, in the beam splitters 41, the center line 27 (the center line in the longitudinal direction) in the direction that intersects with the center line 20 and is perpendicular to the surface of the lens 3 passes through the central position of the pupil when the right eye RE of the user sees the front direction.

The beam splitters 41 and 42 transmit the light from the visual field in the direction of the eyes of the user while reflecting a part of the light from the visual field in a direction substantially parallel to the lens surface, and transmit the light from the eyes (pupil or iris) of the user in the direction of the visual field while reflecting a part of the light from the eyes of the user in the direction substantially parallel to the lens surface.

In FIG. 8, when the light parallel to the center line 27 among the beams of light from the front F of the visual field reaches the beam splitter 41 of the lens 3, almost half light is reflected in the direction substantially parallel to the lens surface, and goes toward the visual field imaging camera 38. In addition, almost half light is transmitted and goes toward the right eye RE of the user.

In FIG. 8, the light parallel to the center line 27 among the beams of light from the right eye RE of the user reaches the beam splitter 41 of the lens 3, almost half light is reflected in the direction substantially parallel to the lens surface, and goes toward the visual line detecting camera 37. In addition, almost half light is transmitted and goes toward the front F of the visual field.

In the frame 2, first light taking modules 41 and 42 configured to take the light from the eyes of the user reflected by the beam splitters 41 and 42 are disposed in the vicinity of the periphery of the lenses 3 and 4. Furthermore, in the frame 2, second light taking modules 44 and 46 configured to take the light from the visual field reflected by the beam splitters 41 and 42 are disposed in the vicinity of the periphery of the lenses 3 and 4. The first light taking modules 43 and 45 and the second light taking modules 44 and 46 are disposed in the vicinity of the opposite sides of the lenses 3 and 4 with each of the beam splitters 41 and 42 interposed therebetween.

The first light taking modules 43 and 45 are first through holes 43 and 45 for taking the light from the eyes of the user. In the grooves 21 and 22 provided inside the right and left rims 10 and 11, first through holes 43 and 45 are disposed at a location in which the light from the right eye RE and the left eye LE of the user reflected by the beam splitters 41 and 42 reaches. The light from the eyes of the user reflected by the beam splitters 41 and 42 passes through each of the first through holes 43 and 45, and enters the visual line detecting cameras 37 and 39 disposed in the vicinity of the first through holes 43 and 45 or in proximity thereto.

The second light taking modules 44 and 46 are second through holes 44 and 46 for taking the light from the visual field. In the grooves 21 and 22 provided inside the right and left rims 10 and 11, second through holes 44 and 46 are disposed at a location in which the light from the front F of the visual field reflected by the beam splitters 41 and 42 reaches. The light from the front F of the visual field reflected by the beam splitters 41 and 42 passes through each of the second through holes 44 and 46, and enters the visual field imaging cameras 38 and 40 disposed in the vicinity of the second through holes 44 and 46 or in proximity thereto.

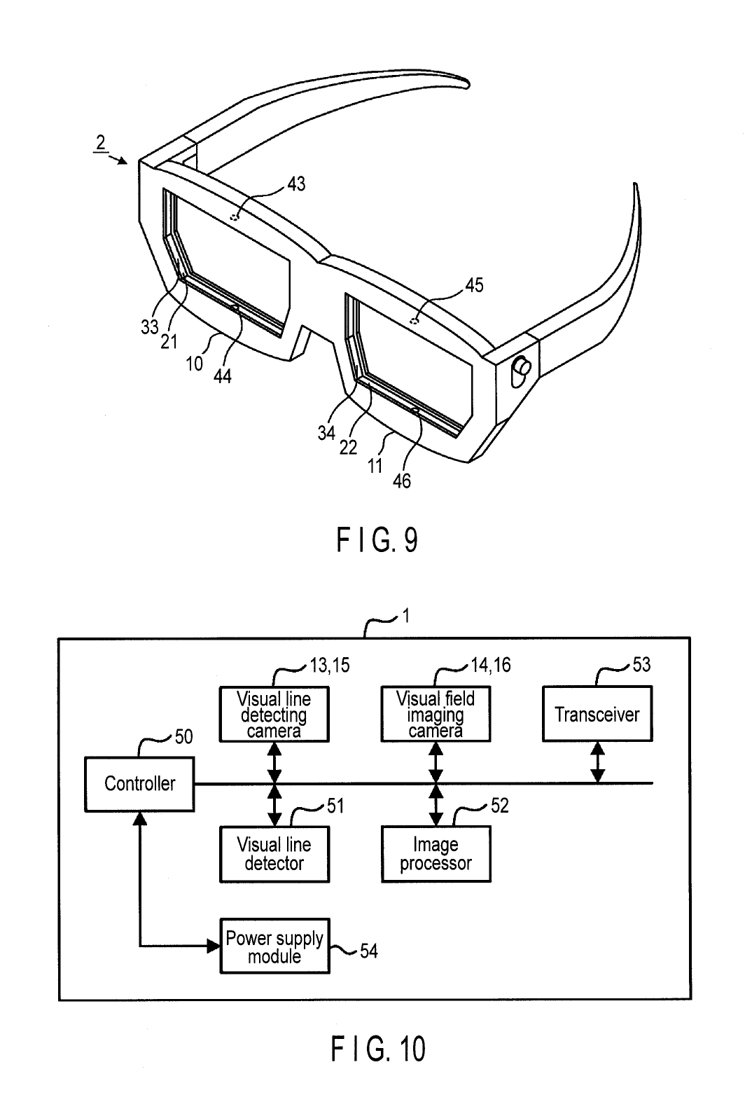

FIG. 9 is an external perspective view illustrating the frame 2 in the state of removing the lenses 3 and 4 in the other example of the visual line detection device 1 illustrated in FIGS. 7 and 8. The right and left rims 10 and 11 are provided with lens fixing grooves 21 and 22, and the first through holes 43 and 45, and the second through holes 44 and 46 are provided on the bottom surfaces 33 and 34 (surfaces in which the side surfaces 3c and 4c of the lens face) of the grooves 21 and 22.

FIG. 10 is a block diagram illustrating the functional elements of the visual line detection device 1. A controller 50 includes a micro controller unit (MCU) serving as an embedded microprocessor in which a computer system is summarized in an integrated circuit. The controller 50 is equipped with a RAM and a ROM, and peripheral functions such as I/O-related function, and controls the overall operation of the visual line detection device 1.

The controller 50 has functions for controlling the visual line detecting cameras 13 and 15, the visual field imaging cameras 14 and 16, a visual line detector 51, an image processor 52, and a transceiver 53 that are connected. The functions thereof are applications executed by the MCU of the interior of the controller 50. The applications are usually stored in the ROM of the interior of the controller 50, and are executed by being read by the MCU in use.

The visual line detector 51 receives the output signal of the visual line detecting cameras 13 and 15, converts the output signal into a signal suitable for communication, and transmits the converted signal to the transceiver 53. For example, the visual line detector 51 converts the position of the pupil of the user from the output signal of the visual line detecting cameras 13 and 15 into the pattern and the data, and calculates the visual line position from the data. Furthermore, the visual line direction and the distance to the object may be converted into the data from the right and left parallax. In addition, the calculation and the conversion to the data of the visual line position may be performed by the visual line detection device 1, or the video data of the visual line detecting camera may be received from the visual line detection device 1 and may be performed by a host device.

The image processor 52 receives the output signal of the visual field imaging cameras 14 and 16, converts the signal into a signal suitable for communication, and transmits the converted signal to the transceiver 53. The transceiver 53 transmits the visual line detection data, the visual field image data or the like to an external host device via an antenna or the like. The power supply module 54 is responsible for control of the battery to be mounted, power-saving management or the like.

The main portions of the controller 50, the visual line detector 51, the image processor 52, and the transceiver 53 are mounted on the main circuit board 18. Furthermore, a part of the power supply module 54 is disposed in the power supply unit 17, and the other part thereof is mounted on the main circuit board 18.

As described above, it is possible to provide the visual line detection device 1 that is thin and lightweight, by providing the beam splitters 23 and 24 inside the lenses 3 and 4, by disposing the first light taking modules 29 and 31 configured to take the light from the eyes of the user reflected by the beam splitters 23 and 24 in the vicinity of the periphery of the lenses 3 and 4, by disposing the second light taking modules 30 and 32 configured to take the light from the visual field reflected by the beam splitters 23 and 24 in the vicinity of the periphery of the lenses 3 and 4, by disposing the first light taking modules 29 and 31 and the second light taking modules 30 and 32 on the opposite sides of the lenses 3 and 4 with each of the beam splitters 23 and 24 interposed therebetween, and by disposing the visual line detecting cameras 13 and 15 and the visual field imaging cameras 14 and 16 near the first light taking modules 29 and 31 and the second light taking modules 30 and 32.

### Second Embodiment

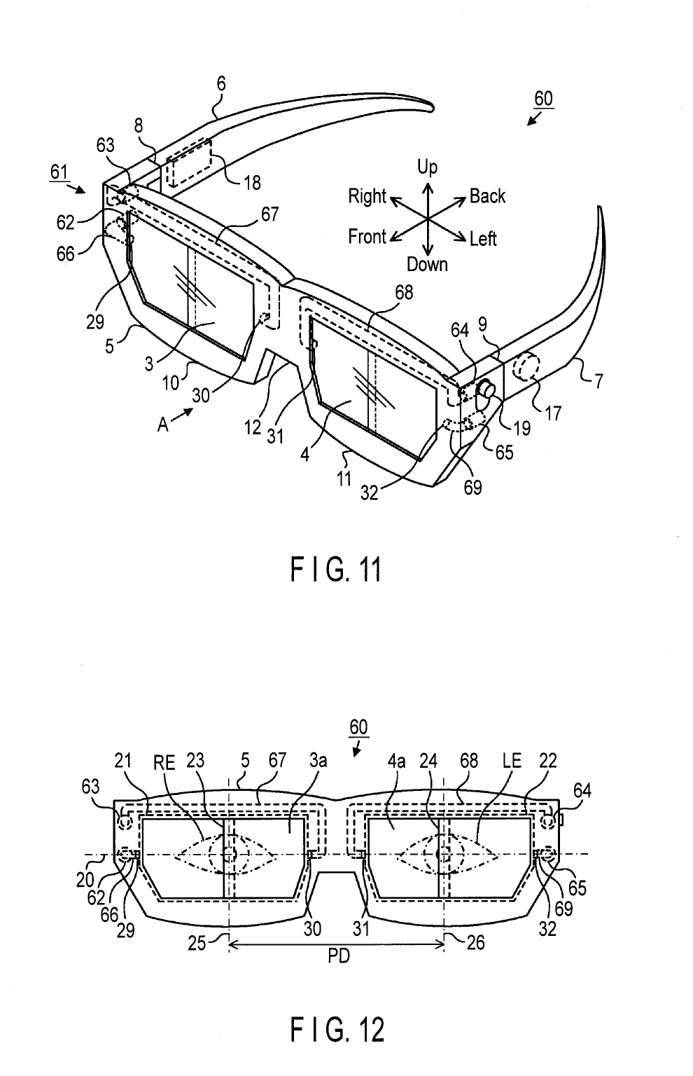

FIG. 11 is an external perspective view illustrating a visual line detection device 60 according to a second embodiment. FIG. 12 is a front view illustrating the visual line detection device 60 according to the second embodiment. For each part of this second embodiment, the same parts as those of the first embodiment illustrated in FIG. 1 are denoted by the same reference numerals. The second embodiment is different from the first embodiment in that, regarding the arrangement of the camera, in the first embodiment, the cameras 13 and 15 configured to photograph the eyes of the user are disposed in the vicinity of the first light taking modules 29 and 31, and the cameras 14 and 16 configured to photograph the visual field are disposed in the vicinity of the second light taking modules 30 and 32, but in the second embodiment, cameras 62 and 64 configured to photograph the eyes of the user and cameras 63 and 65 configured to photograph the visual field are disposed on the right temple 6, and the left temple 7.

The light from the first light taking modules 29 and 31 is optically guided to the camera 62 and 64 configured to photograph the eyes of the user by light guides 66 and 68, and the light from the second light taking modules 30 and 32 is optically guided to the cameras 63 and 65 configured to photograph the visual field by light guides 67 and 69.

One ends of the light guides 66 and 68 are disposed in the vicinity of the first light taking modules 29 and 31, and the cameras 62 and 64 configured to photograph the eyes of the user are disposed in the vicinity of the other ends of the light guides 66 and 68. One ends of other light guides 67 and 69 are disposed in the vicinity of the second light taking modules 30 and 32, and the cameras 63 and 65 configured to photograph the visual field are disposed in the vicinity of the other ends of other light guides 67 and 69.

For example, a fiberscope or the like is used as the light guides 66, 67, 68, and 69. The leading end of the fiberscope is arranged immediately behind the first through holes 29 and 31 serving as the first light taking modules 29 and 31 to take the light, and an optical fiber is disposed inside the rims 10 and 11 of the frame 61 to guide the light up to the cameras installed in the right temple 6 and the left temple 7, and a distal end of the fiberscope is connected to the camera.

In FIGS. 11 and 12, the visual line detecting camera 62 and the visual field imaging camera 63 are placed in the right temple 6, and the visual line detecting camera 64 and the visual field detecting camera 65 are placed in the left temple 7. The placement of these cameras can be freely changed by changing an arrangement of the fiberscope or the like. Furthermore, it is possible to install the camera in the size allowed by the internal volumes of the temples 6 and 7, and it is possible to install a larger camera than it is in the rims 10 and 11.

As described above, it is possible to provide the visual line detection device 1 that is thin and lightweight, by providing the beam splitters 23 and 24 inside the lenses 3 and 4, by placing the first light taking modules 29 and 31 configured to take the light from the eyes of the user reflected by the beam splitters 23 and 24 in the vicinity of the periphery of the lenses 3 and 4, by placing the second light taking modules 30 and 32 configured to take the light from the visual field reflected by the beam splitters 23 and 24 in the vicinity of the periphery of the lenses 3 and 4, by placing the first light taking modules 29 and 31 and the second light taking modules 30 and 32 on the opposite sides of the lenses 3 and 4 with each of the beam splitters 23 and 24 interposed therebetween, and by optically guiding the light to the cameras disposed in the temples 6 and 7 by the light guides 66, 67, 68, and 69.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A visual line detection device comprising:
a lens;
a frame configured to hold the lens;
a beam splitter inside the lens, configured to transmit light from a visual field in a direction of eyes of a user while reflecting a part of the light from the visual field in a direction substantially parallel to a surface of the lens, and transmit the light from the eyes of the user in a direction of the visual field while reflecting the part of the light from the eyes of the user in the direction substantially parallel to the surface of the lens;
a first light taking module in the vicinity of the periphery of the lens in the frame, configured to take the light from the eyes of the user reflected by the beam splitter; and
a second light taking module in the vicinity of the periphery of the lens in the frame, configured to take the light from the visual field reflected by the beam splitter.

2. The device of claim 1, wherein
the first light taking module comprises a first through hole on a surface in which a side surface of the lens in the frame faces, and
the second light taking module comprises a second through hole on a surface in which the side surface of the lens in the frame faces.

3. The device of claim 1,
wherein the first light taking module and the second light taking module are in the vicinity of the opposite sides of the lens with the beam splitter interposed therebetween.

4. The device of claim 1,
wherein the first light taking module and the second light taking module are in the vicinity of the left and right of the lens with the beam splitter interposed therebetween.

5. The device of claim 1,
wherein the first light taking module and the second light taking module are in the vicinity of the top and bottom of the lens with the beam splitter interposed therebetween.

6. The device of claim 1, wherein
a camera configured to photograph the eyes of the user is in the vicinity of the first light taking module, and
a camera configured to photograph the visual field is in the vicinity of the second light taking module.

7. The device of claim 1, wherein
one end of a light guide is placed in the vicinity of the first light taking module,
a camera configured to photograph the eyes of the user is placed in the vicinity of the other end of the optical waveguide,
one end of another light guide is placed in the vicinity of the second light taking module, and
another camera configured to photograph the visual field is placed in the vicinity of the other end of the other optical waveguide.

8. A method comprising:
transmitting light from a visual field in a direction of eyes of a user while reflecting a part of the light from the visual field in a direction substantially parallel to a surface of a lens, using a beam splitter inside the lens;
transmitting the light from the eyes of the user in a direction of the visual field while reflecting the part of the light from the eyes of the user in the direction substantially parallel to the surface of the lens, using the beam splitter;
taking the light fro the eyes of the user reflected by the beam splitter, using a first light taking module in the vicinity of the periphery of the lens in the frame; and
taking the light from the visual field reflected by the beam splitter, using a second light taking module in the vicinity of the periphery of the lens in the frame.
